(19) United States
(12) Patent Application Publication
(10) Pub. No.: US 2007/0264094 A1
(43) Pub. Date: Nov. 15, 2007

(54) Unibit with replacement blade

(76) Inventor: Scott C. Seeley, Grand Rapids, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/430,458

(22) Filed: May 9, 2006

(51) Int. Cl. B23B 51/00

(52) U.S. Cl. 408/224

(57) ABSTRACT

A unibit with replacement blade of the invention provides economical refreshing of the many cutting facets of a unibit drill bit with a unibit replacement blade that is releasably secured in the unibit body with a simple blade lock mechanism. In one aspect of the invention, the blade lock is an eccentric cam member that rotates into and out of locking engagement with the blade. Other blade locks include clamping screws, screws through the blade, cam plates, tapered blades, and blade receiving grooves. Another aspect of the invention provides a replaceable tip drill. The unibit desirably is provided with two or more replaceable blades positioned symmetrically around the axis of the drill.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO A SEQUENCE LISTING

Not Applicable

### BACKGROUND OF THE INVENTION

The invention relates generally to hole drilling bits that are used to drill holes in sheet metal and other sheet materials. More specifically, the invention relates to a stepped multiple hole size drill bit, which is commonly known as a unibit or step drill. Unibits are relatively more expensive than single size twist drills and tend to be used frequently because of their versatility of being capable of drilling a variety of hole sizes. This frequent use also causes them to have a relatively short life. Further, unibits are typically not re-sharpened when worn because of the level of effort and expense to sharpen their many cutting facets.

One object of the present invention is to provide a unibit that can economically be resharpened by means of easily replaceable blades.

### BRIEF SUMMARY OF THE INVENTION

Accordingly, a unibit with a replacement blade of the invention provides economical refreshing of the many cutting facets of a unibit with a unibit body and replacement blade that is releasably secured to the unibit body by a blade lock without a complicated mechanism. In one aspect of the invention, the blade lock is an eccentric cam member that rotates into and out of locking engagement with the blade. In other aspects of the invention, other types of novel blade locks are employed to lock the replacement blade in place. Another aspect of the invention provides a replaceable tip drill and a fastener that urges the tip drill into a seated position in the unibit body. The unibit of the invention may be provided with one or more replaceable blades.

These and other features or benefits of the invention will be recognized from this specification, including the claims and the drawing figures, by one having ordinary skill in the art and by those who practice the invention.

### DESCRIPTION OF THE SEVERAL VIEWS OF THE DRAWING

FIG. 1 is an exploded side elevation view of a unibit with replacement blade of the invention;

FIG. 2 is a top plan view of a replacement blade thereof, along line II-II of FIG. 1;

FIG. 3 is a bottom plan view thereof; and

FIG. 4 is a top plan view of a body of the unibit with replacement blade of FIG. 1.

FIG. 5 is an end view of the embodiment of FIG. 1.

FIG. 6 is an end view of a second embodiment of the present invention.

FIG. 7 is an end view of a third embodiment of the present invention.

FIG. 8 is an end view of a fourth embodiment of the present invention.

FIG. 9 is an end view of a fifth embodiment of the present invention.

FIG. 10 is a perspective view of another embodiment of the present invention.

FIG. 11 is a plan view of the unibit of FIG. 10.

FIG. 12 is a side elevational view of the unibit of FIG. 10.

FIG. 13 is an end view of the unibit of FIG. 10, taken from the tip end of the drill.

FIG. 14 is a side elevational view of a seventh embodiment in the present invention.

FIG. 14a is an enlarged fragmentary view of the edge of the embodiment of FIG. 14, showing an undercut at the junction between the successive steps of the unibit body.

FIG. 15 is a plan view of the embodiment of FIG. 14.

FIG. 16 is a side elevational view of the clamping screw employed in the embodiment of FIG. 14.

FIG. 17 is an end view of FIG. 16.

FIG. 18 is a perspective view of the replacement blade employed in the embodiment of FIG. 14.

FIG. 19 is a side elevational view of the replacement blade of FIG. 18.

FIG. 20 is an edge view of the replacement blade of FIG. 18.

FIG. 21 is a cross sectional view taken along line 21-21 of FIG. 19.

FIG. 22 is a side elevational view of the tip drill of the embodiment of FIG. 14.

FIG. 23 is a plan view of the tip drill of FIG. 22.

FIG. 24 is an end view of the tip drill of FIG. 22.

### DETAILED DESCRIPTION OF THE INVENTION

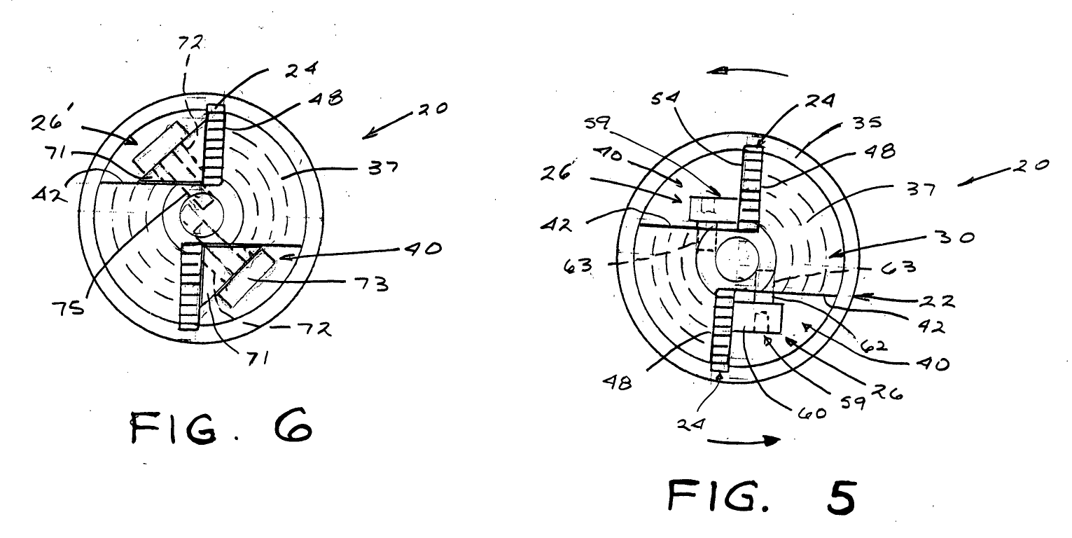

With general reference to the drawing figures, a first embodiment of a unibit with a replacement blade according to the invention 20 has at least a body 22, a replacement blade 24, and a blade lock 26. The body is a body of rotation about an axis “A” and has two opposing ends 27 and 29 (FIG. 4). A shaft portion 28 extends from one end 29 (first end) toward the opposing end 27 (second end) and a generally conical head 30 extends from the opposing end 27 toward the shaft. The head 30 includes a tip 31 at end 27 and a base 33 that joins the shaft 28. The base can have an enlarged rim 35 that restrains the head from passing entirely through a drilled hole in sheet material. The enlarged rim is optional and may not be employed in all cases. The inclined outer surface 37 of head 30 includes a series of steps 32 of progressively increasing diameter and a series of ramps 34 interposed between and connecting adjacent steps.

The shaft 28 is adapted to be secured into a rotating machine, such as a drill or the like (not shown). For example, the unibit 20 may be used with one-quarter inch, one half inch or other sizes of drills and the like. Thus, the shaft may be sized accordingly and in consideration of torque loading on the head 30, as is understood by one having ordinary skill in the art. The body 22 may be made of any appropriate cutting tool holding or foundation material, such as 4140 or 6150 steel. Unlike conventionally known unibits, which have a cutting edge integral with their body, the cutting edge of the unibit according to the invention is incorporated in a separate replacement blade. Thus, the body does not need to be formed of the same hardened cutting tool material as the blades and their cutting edges. This can reduce the cost of the tool significantly.

A blade receiving recess 40 is formed in each side of the head 30 and releasably receives a corresponding replacement blade 24. As shown in the drawings, the blade receiving recess is a generally V-shaped sectional void in the head 30 that resembles a quarter-section-like portion from the head. However, this is not a true quarter-section, in that the sides or walls 42 and 48 of the section are not aligned (coplanar) with the axis of rotation “A.” Rather, as shown in the end view of the FIG. 5, the plane of side 48 is overextended beyond the axis. The extent of overextension is preferably about the thickness of the replacement blade 24, such that a cutting edge 46 of the replacement blade at a face surface 54 of the blade lies in a plane that extends generally through the axis “A.”

The replacement blade 24 is a generally triangular shaped plate member that is constructed of a suitably hard material, such as 6264 tool steel, for example. The blade has two long legs 44 and 45 and a short leg 47. One of the long legs 44 forms an inclined outer edge of the blade. This leg has a stepped cutting edge 46 that is defined by a series of flats 50 and ramps 52. In use, the head and blade will be rotated and the blade cutting edge will be along a leading face or surface 54 of the blade, relative to the direction of rotation.

The flats 50 are generally parallel with the reference axis “A” when the blade 24 is installed in the head 30, and are spaced a progressively increasing distance from the axis. Again, as with the stepped configuration of the head, the ramps 52 of the replacement blade extend between adjacent flats. The flats 50 and ramps 52 of the blade correspond to the steps 32 and ramps 34 of the head but extend slightly radially outward from the head 30. Thus, the cutting edge is exposed to do its job of cutting, while the head is a foundation for the blade and holds and positions the blade.

The blade lock 26 releasably secures the blade 24 in the receiving recess 40 and is configured in one embodiment of the invention as an eccentric cam 59 rotatably mounted in the blade receiving recess 40 of the head 30. The blade lock 26 has an eccentric cam head 60 on a pivot shaft 62. The shaft extends into a corresponding hole in the head. Preferably, the shaft and the hole are provided with cooperating screw threads that engage in forced fit. Thus, disengagement or removal of the blade lock from the head in use is resisted by the force fit engagement of the shaft with the head and their screw threading.

Another feature of the invention is that an inner end 63 of the blade receiving recess 40 in the head 30 of the unibit is curved outwardly. This curved end directs metal shavings radially outwardly from the tool and prevents shavings from collecting in the recess.

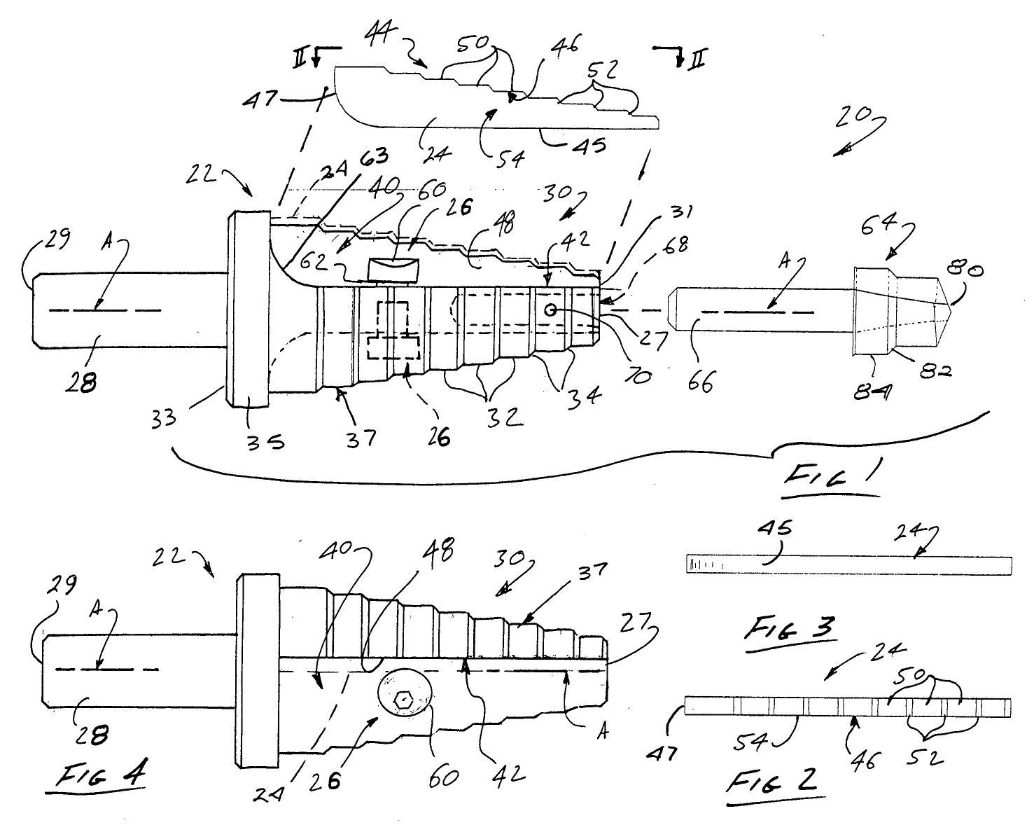

In another aspect of the invention, shown in FIG. 6, rather than locking the blade in place with the eccentric cam 60 of FIG. 1, the blade can be locked in place by a blade lock 26′ that includes a cam plate in the form of angle plate 71 that bears against the outside of the blade. A bolt 73 extends through a slot 72 in the angle plate and screws into a threaded, inclined opening 75 in the body of the unibit. Tightening the bolt urges the bolt against an inclined outer surface of the angle plate and causes the angle plate to clamp the blade in position.

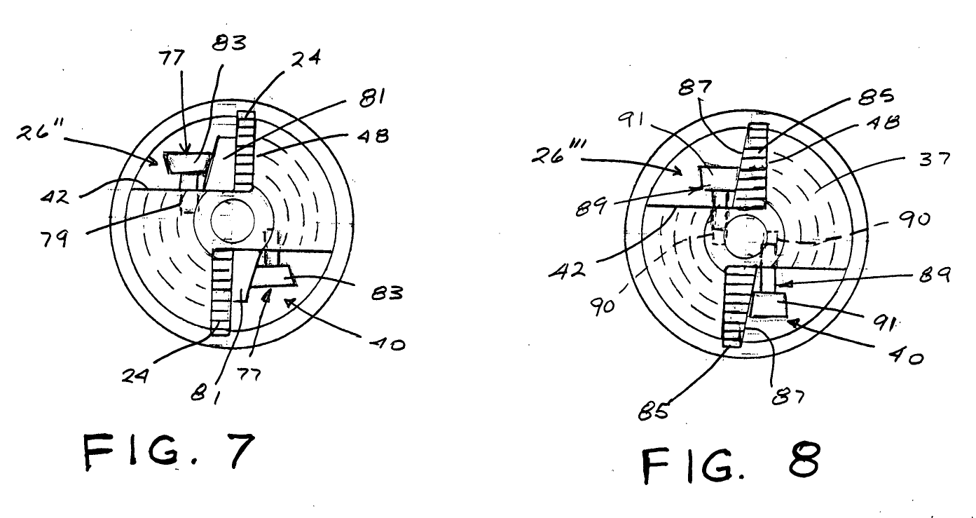

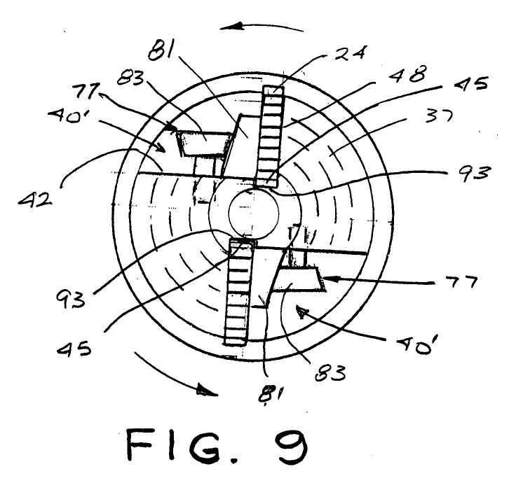

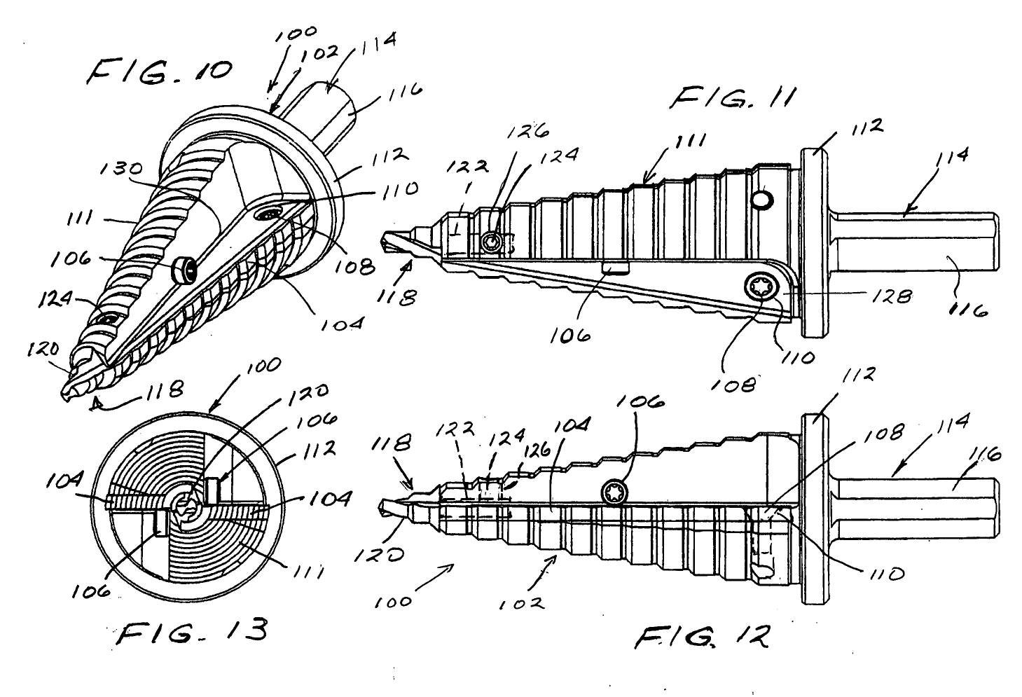

In another aspect of the invention shown in FIG. 7, blade lock 26″ includes a screw or bolt 77 that extends into a threaded opening 79 that is parallel with the side of the blade. A cam plate 81 with an inclined side is positioned between the blade and a screw head 83, so that the head of the screw urges the plate against the blade as the screw is screwed into the opening.

As an alternative to the use of a cam plate, the replacement blade itself 85 can be formed with an inclined side 87, as shown in blade lock 26″′ in FIG. 8. In this embodiment, axial movement of screw 89 into hole 90 causes the head 91 of the screw to engage the inclined surface and urge the blade into a locked position. The head of the screw can be tapered to mate with the incline of the sides of the blade.

In another aspect of the invention, shown for exemplary purposes in FIG. 9, the blade receiving recess 40′ of the body of the unibit can be provided with an elongated groove 93 that extends axially in wall 42 adjacent wall 48. The groove receives an inner edge 45 of the blade and holds it in place while any of the blade locks clamp the blade in position. The groove 93 for the blade lock is shown for illustrative purposes in connection with the embodiment of FIG. 9. However, this groove also can be used for other embodiments.

Another feature of the invention is a replaceable tip drill 64 that is releasably mounted in the tip of the unibit. The tip drill 64 may be provided either in combination with a unibit having a replacement blade feature, or in a unibit having a fixed, non-replacement blade. Tip drill 64 includes a shaft 66 that is securely and releasably received in a cooperating shaft receptacle 68 in the tip 31 of the unibit head 30. A set screw 70 or the like may be used to secure the tip drill to the unibit head. Other means for non-rotatably securing the tip drill in the head can be employed, including a mating non-circular (e.g., square) shaft and receptacle. The tip drill is formed of a cutting tool material, such as 6240 steel. The tip drill has a sharpened drill point 80 for starting a drill hole. Desirably, the tip drill also has at least one drill step comprising a ramp 82 and a flat 84 at an increased diameter that mates with the smallest diameter flats and ramps at the top of the body. It should be noted that a tip drill is not necessarily employed in every case. In some instances, such as when the bit is employed in sheet material having a pre-formed hole, the bit might not employ a tip drill at all.

The unibit 20 has at least one replacement blade according to the inventive concept. As shown in FIG. 1, a second replacement blade preferably is provided in a generally diametrically opposed and rotationally balanced position. One having ordinary skill in the art may identify uses and situations where more than two blades is desired, in which case the blades are disposed symmetrically around the head.

Another embodiment of the present invention is shown in FIGS. 10-13. In this embodiment, as in the previous embodiments, unibit 100 includes a body 102, a replacement blade 104, and a blade lock. The blade lock includes a screw 106 positioned adjacent to the replacement blade that extends parallel to or preferably at a slight inward angle toward the replacement blade. The blade lock also includes a screw 108 that extends through an opening 110 in the heel 128 of the blade. The unibit (also called a step drill) can include an enlarged rim 112 at the base of the conical head 111 to prevent the drill from passing all the way through an opening in sheet material. The enlarged rim is optional and may not be employed in all circumstances. A mounting shaft 114 extends axially from the base of the head. Shaft 114 has flattened portions 116 spaced around the shaft to prevent the shaft from rotating in the driver. The drill includes a replaceable drill tip 118 having a stepped conical head 120 mounted on a shaft 122 that extends into an opening in the end of the drill. Shaft 122 has a flattened surface that faces set screw 124, which is threaded in opening 126 adjacent the end of the drill. Set screw 124 holds the tip drill in place.

The primary difference between the drill in FIGS. 10-13 and the drill of FIG. 1 is the manner in which the replacement blade is mounted to the head of the drill. Screw 106 is similar to screw 60 in FIG. 1, except that it does not require an eccentric outer surface as in FIG. 1. Preferably, screw 106 is at a slight angle with respect to the surface of the blade, and the head of the screw has a slightly tapered surface ( similar to FIGS. 7-9).

The screw thus tightens against the sides of the blade as it is advanced inwardly into the tapered screw hole. Another distinctive feature of the embodiment of FIGS. 10-13 is that screw 108 firmly retains the heel 128 of the blade in place. Screw 108 has a head with a tapered outer surface that mates with a tapered surface in opening 110 so that screw 108 can be countersunk into the opening and still clamp the heel of the blade to the body of the unibit. A screw having a head larger than the opening through which the screw fits also would serve the same clamping purpose, although a protruding screw head could have the disadvantage of impairing somewhat the discharge of shavings from the drill bit. The use of the additional clamping screw 108 more securely attaches the replacement blade in place in the body of the unibit.

In order to provide an even more secure attachment of the replacement blade to the body of the unibit, the recess in which the blade of FIG. 10 is mounted can have a groove 130 formed therein in which the adjacent edge of the unibit fits, in the manner of groove 93 in FIG. 9.

The blade formed in the foregoing manner provides a more secure attachment for the replacement blade. This embodiment is therefore preferred for at least some applications.

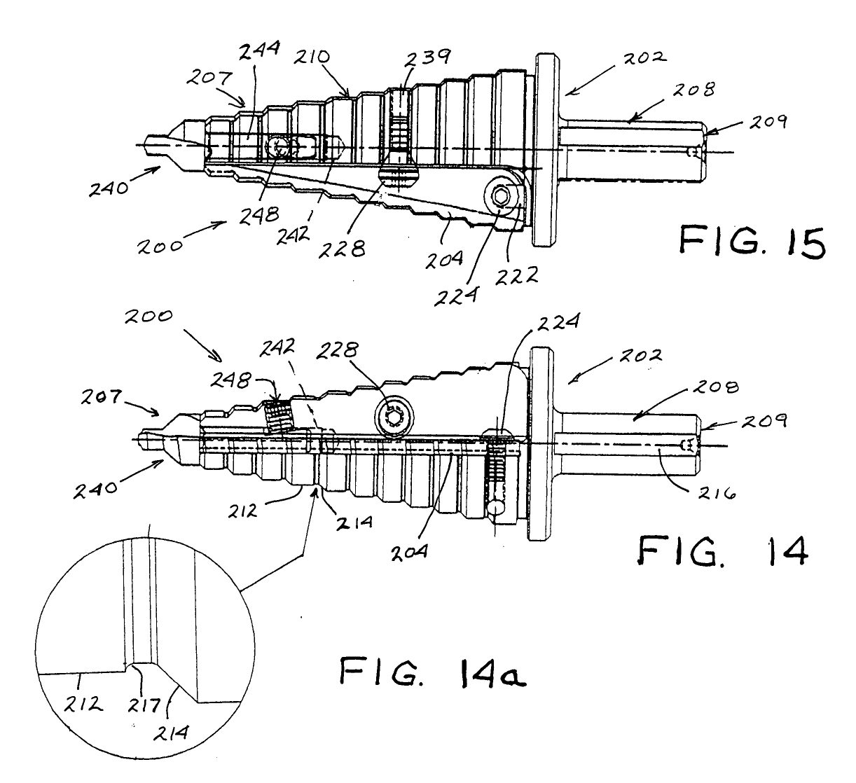

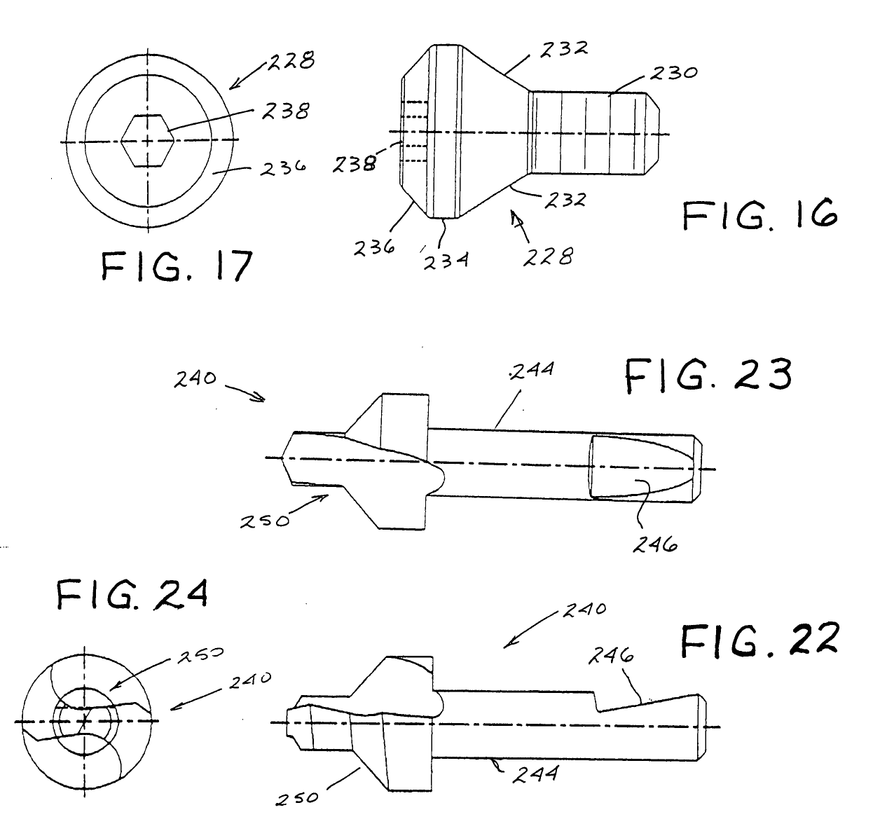

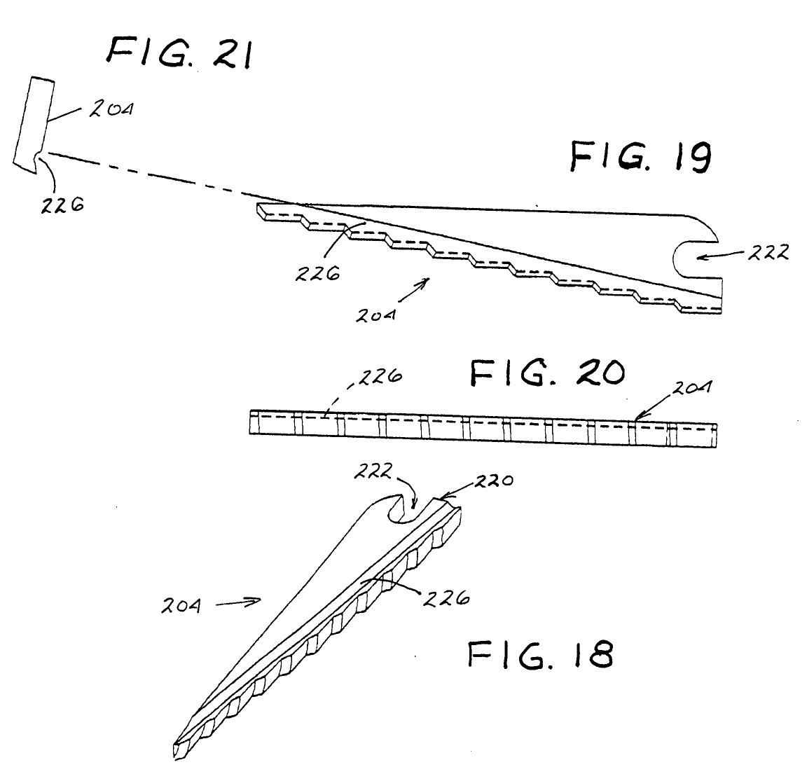

A seventh embodiment 200 of the present invention is shown in FIGS. 14-24. Unibit 200 is the preferred embodiment of the present invention and includes a body 202 and a replacement blade 204. The body includes a shaft 208 at one end 209 and a conical head 210 at a second end 207 of the body, all as in the prior embodiments. The outer surface of head 210 includes a plurality of steps 212 progressively increasing in diameter and a series of ramps 214 interposed between the adjacent steps.

Shaft 208 includes flattened portions 216 spaced around the periphery of the shaft for non-rotatably mounting the shaft in a driver chuck.

The head 210 of the body is similar to the previous embodiment except that a small undercut portion 217 is formed between the adjacent steps and ramps of each step in the drill, as shown in FIG. 14a. In a typical drill having a maximum outer diameter of about 1 inch, the undercut may be approximately 0.008 inches deep.

Replacement blade 204 is constructed in a manner similar to replacement blade 104 of FIGS. 10-13, except that the heel 220 of the blade includes a slot 222 instead of a hole. A screw 224 extends through the slot into a threaded opening in the head of the drill body. The slot makes it possible to adjust blade position or replace a blade simply by loosening the screw and sliding the blade out of the slot instead of having to remove the screw 224 completely from the body.

Another feature of replacement blade 204 is that the blade includes a groove 226 adjacent and parallel to the leading edge of the blade. This groove improves the operation of the blade.

The replacement blade 204 is held in position by means of clamping screw 228, shown in FIGS. 16 and 17. In an exemplary embodiment, screw 228 includes a threaded shank 230, which is about 0.13 inches in diameter and 0.22 inches long. A beveled collar 232 is formed at an angle of about 30 degrees from the axis of the screw. A cylindrical band 234 having a diameter of about 2.6 inches adjoins the tapered collar, and an inwardly tapered outer end 236 is formed at the end of the screw. A hex drive opening 238 is formed in the end of the screw for rotating the screw.

The screw fits in a hole 239 having a tapered opening that mates with tapered collar 232. When the screw first enters the hole, the screw threads permit some sideways movement of the screw in the hole but as the screw advances further into the hole, the hole draws the screw into more fixed axial alignment with the hole. When the tapered screw collar engages the tapered opening in the hole, the band on the screw is brought tightly into holding engagement with the side of the blade. Thus, an out of round or cam type of screw connection is not required in this embodiment. To further improve the blade holding power of the screw, the hole can be at a slight angle, so that the collar on the screw is brought into increasingly tight contact with the side of the blade as the screw is advanced into the hole.

Another feature of this embodiment is the tip drill 240 that fits in an opening 242 in the end of the drill. Tip drill 240 has a shank 244, which has an inclined locking surface 246 thereon. A set screw 248 extends at an angle through a threaded hole in the body, such that an end of the set screw bears against the inclined locking surface and urges the shank of the tip drill axially inwardly into the opening in the drill body so as to tighten the engagement of the tip drill in the drill body as the set screw is tightened. The tip drill has a cutting surface and step on the outer end 250 thereof that mates with the steps of the drill formed along the head of the drill body and the outer end of the replacement blade.

In operation, step drill 200 operates in the same manner as the previous embodiments.

The foregoing embodiments are representative of preferred methods for securing a replacement blade to the body of a unibit drill. Other methods for securing a blade to the body of a unibit drill could be employed, as long as the blade is clamped securely to the body and yet is easily removable for replacement.

One having ordinary skill in the art and those who practice the invention will understand that various modifications and improvements may be made without departing from the disclosed inventive concept. Various relational terms, including left, right, front, back, top, and bottom, for example, are used in the detailed description of the invention and in the claims only to convey relative positioning of various elements of the claimed invention and are not otherwise used to limit the scope of the invention.

What is claimed is:

1. A unibit with replacement blade, comprising:
a body of rotation about an axis that has first and second opposing ends, the body having a shaft extending along the axis toward a second end from the first end and having a head extending along the axis toward the first end from the second end, the head being generally conical, with a tip at the second end and a base at an opposite end of the head, the head also having a blade receiving recess extending in an axial direction between the tip and the base of the head;
a replacement blade releasably secured in the recess, the blade having a cutting edge on an outer surface that includes a series of steps and ramps of increasing diameter, the blade being secured in the receiving area so the cutting edge extends beyond the body in a direction that is radially outward from the axis; and
a blade lock that releasably secures the blade in the receiving area.

2. The unibit of claim 1 wherein the blade lock is an eccentric cam that is rotatably mounted on the body and that rotates into and out of locking engagement with the blade, the blade lock clamping the blade against a side of the blade receiving recess.

3. The unibit of claim 2 further including a tip drill with a cutting tip at one of two opposing ends and a shaft extending toward the cutting tip from the other of the two opposing ends, and wherein the body has a cooperating shaft receptacle at the body second end, the tip drill shaft fitting in the shaft receptacle of the body, the unibit further including means for releasably securing the shaft in the shaft receptacle and preventing rotation of the shaft in the shaft receptacle.

4. The unibit of claim 3 wherein the tip drill shaft is releasably secured in the shaft receptacle with a set screw.

5. The unibit of claim 1 further including a tip drill with a cutting tip at one end and a mounting shaft at the other end, and wherein the body has a cooperating shaft receptacle at the tip of the body, the tip drill shaft further being releasably secured in the shaft receptacle.

6. The unibit of claim 5 wherein the tip drill shaft is releasably secured in the shaft receptacle with a set screw.

7. The unibit of claim 1 wherein the replacement blade is a first of at least one replacement blade, wherein each cooperating set of replacement blade, blade receiving area, and blade lock is distributed about the axis and configured so the unibit is rotationally balanced.

8. A unibit with replacement blade, comprising:
a replacement blade that has two opposing ends that define a length along a reference axis, the blade being a generally triangular plate member with two long legs and a short leg, one of the long legs having a cutting edge that is defined by a series of ramps and flats, the flats being generally parallel with the reference axis and being spaced a progressively increasing distance from the axis;
a body of rotation about the axis that has first and second opposing ends corresponding to the blade opposing ends, the body having a shaft extending along the axis toward a second end from the first end and having a head extending along the axis toward the first end from the second end, the head having a blade receiving recess extending axially into which the blade is releasably secured, the head further having a generally conical configuration that cooperates with the blade so the cutting edge extends beyond the body in a direction that is radially outward from the axis; and
a blade lock that releasably secures the blade in the receiving area.

9. The unibit of claim 8 wherein the blade lock is an eccentric cam that is rotatably mounted on the body and that rotates into and out of locking engagement with the blade.

10. The unibit of claim 9 further including a tip drill with a cutting tip at one of two opposing ends and a shaft extending toward the cutting tip from the other of the two opposing ends, and wherein the body has a cooperating shaft receptacle at the body second end, the tip drill shaft further being releasably secured in the shaft receptacle.

11. The unibit of claim 10 wherein the tip drill shaft is releasably secured in the shaft receptacle with a set screw.

12. The unibit of claim 8 further including a tip drill with a cutting tip at one of two opposing ends and a shaft extending toward the cutting tip from the other of the two opposing ends, and wherein the body has a cooperating shaft receptacle at the body second end, the tip drill shaft further being releasably secured in the shaft receptacle.

13. The unibit of claim 12 wherein the tip drill shaft is releasably secured in the shaft receptacle with a set screw.

14. The unibit of claim 8 wherein the replacement blade is a first of at least one replacement blade, wherein each cooperating group of replacement blade, blade receiving area, and blade lock is distributed about the axis and configured so the unibit is rotationally balanced.

15. In a unibit having a shaft and an opposing tip end with a generally conical body extending between the tip and the shaft, the body being defined along an axis of rotation by an outer surface that includes a series of steps of progressively increasing diameter and a series of ramps interposed between adjacent steps, the unibit being adapted to cut a hole in a preselected material by rotation of the body about the axis in a preselected direction, the improvement comprising:
a blade receiving recess defined in the conical body, the recess having a blade support surface that extends along the axis and faces forward relative to the preselected rotation direction;
a replacement blade releasably secured in the receiving recess in abutting engagement with the blade support surface, the blade having a cutting edge that corresponds to the steps and ramps of the body, the blade being secured in the receiving recess such that the blade cutting edge extends radially beyond the body; and
a blade lock that releasably secures the blade against the blade support surface in the receiving recess, the lock having a cam rotatably mounted in the blade receiving recess, the cam being positioned to rotate between a locked position in which the blade is clamped between the cam and the blade support surface and an open position in which the blade is released.

16. The improvement of claim 15 further including a tip drill with a cutting tip at an outer end and a shaft extending toward the cutting tip from an inner end, the body of the unibit having a cooperating shaft receptacle at the tip thereof, the tip drill shaft further being releasably and non-rotatably secured in the shaft receptacle.

17. The unibit of claim 16 wherein the tip drill shaft is releasably secured in the shaft receptacle with a set screw.

18. A unibit comprising:
a generally conical body having an axis, the body having a base and a tip at opposite axial ends thereof and having an inclined outer surface extending between the base and the tip;
a mounting shaft extending axially from the base for mounting the unibit in a rotating tool;
an axially extending recess in at least one side of the body, the recess being formed in the outer surface of the conical body and extending inwardly toward an interior of the body;
a replaceable blade that fits in the recess, the blade having a stepped cutting surface on an outer side that extends outwardly beyond the outer surface of the conical body, such that the cutting surface of the blade engages edges of a hole in a work piece before the work piece engages the body; and
a blade lock that releasably holds the blade in a secure cutting position in the recess in the body.

19. A unibit as in claim 18 wherein the unibit includes a plurality of replaceable blades mounted in recesses positioned symmetrically around the axis of the body.

20. A unibit as in claim 19 wherein the unibit includes two replaceable blades mounted on generally opposite sides of the body.

21. A unibit as in claim 18 wherein the blade lock comprises a threaded shaft having an eccentric head, the shaft being received in a threaded opening positioned in the recess on a side of the blade opposite to a side of the recess that engages a side of the blade, the blade lock being positioned such that rotation of the shaft moves the eccentric head between a released position, where the blade is disengaged and can be removed, and a locked position, wherein the eccentric head engages the blade and clamps the blade between the eccentric head and the side of the recess.

22. A unibit as in claim 18 wherein one side of the blade engages a side of the recess that is oriented so as to position the blade in a generally radial outwardly facing position, the blade lock comprising a threaded shaft that engages a threaded opening in the body, with a head on the shaft engaging an opposite side of the blade in clamping fashion when the threaded shaft is rotated.

23. A unibit as in claim 22 wherein the head of the blade lock and the blade comprise a beveled interface that creates a wedging action against the blade that clamps the blade against the one side of the recess when the blade lock is rotated so as to be axially displaced inwardly.

24. A unibit as in claim 22 wherein a wedge-shaped clamping plate is positioned between the threaded shaft and the blade, the threaded shaft having a head that engages an inclined surface on the clamping plate as the shaft is rotated, such that rotation of the shaft in one direction produces an increasing clamping force on the clamping plate against the replaceable blade.

25. A unibit as in claim 22 wherein the blade lock comprises:
A wedge shaped clamping plate having an inner surface that abuts the opposite side of the blade and a downwardly and outwardly inclined outer surface, the blade lock further including a threaded shaft that is received in a threaded opening in the body and has a head thereon that engages the inclined outer surface of the clamping plate so as to deliver increasing inward clamping force against the replacement blade as the threaded shaft is rotated and displaced axially inwardly into the threaded opening.

26. In a unibit having a shaft and an opposing tip end with a generally conical body extending between the tip and the shaft, the body being defined along an axis of rotation by an outer surface that includes a series of steps of progressively increasing diameter and a series of ramps interposed between adjacent steps, the unibit being adapted to cut a hole in a preselected material by rotation of the body about the axis in a preselected direction, the improvement comprising:
A replaceable tip drill mounted in the tip of the body, the tip drill including a cutting head mounted on an outer end of a shaft, the body of the unibit having a cooperating shaft receptacle at the tip thereof, the tip drill shaft further being releasably and non-rotatably secured in the shaft receptacle.

27. The improvement of claim 26 wherein the cutting head comprises a cutting tip at an outer end of the cutting head and at least one stepped cutting surface of larger diameter positioned rearwardly from the cutting tip.
